(19) United States
(12) Patent Application Publication
(10) Pub. No.: US 2026/0170452 A1
(43) Pub. Date: Jun. 18, 2026

(54) Leveraging Machine-Learning Models for Determining a Collection Sequence

(71) Applicant: Maplebear Inc., San Francisco, CA (US)

(72) Inventors: Ahsaas Bajaj, Jersey City, NJ (US); Kevin Charles Ryan, San Francisco, CA (US); Christopher Billman, Chicago, IL (US); Benjamin Knight, Oakland, CA (US); Shishir Kumar Prasad, San Ramon, CA (US); Caleb Grisell, Los Angeles, CA (US); Mickeyas Alemayehu, Rockville, MD (US)

(21) Appl. No.: 18/981,600

(22) Filed: Dec. 15, 2024

(51) Int. Cl. G06Q 10/087; G06N 3/084

(52) U.S. Cl. CPC G06Q 10/087; G06N 3/084

(57) ABSTRACT

Embodiments are described for leveraging machine-learning models to determine a collection sequence of items of an order. Sequences for collecting a plurality of items of an order are determined, and each of the sequences has a different arrangement of the plurality of items. Total appeasement values are determined for each of the sequences based in part on an appeasement model. Collection times are predicted for each of the sets of sequences. The sequences of the set are scored based in part on the total appeasement values and the collection times. A sequence is selected from the set based in part on the scoring. The selected sequence is provided to a picker client device. A picker associated with the picker client device may fulfill the order and collect the plurality of items in accordance with the selected sequence.

### BACKGROUND

Conventional online platforms provide shoppers with lists of items to purchase for their users. However, such platforms may provide only a list of items to a shopper to collect from a retail location without regard to how an order in which items are collected can negatively affect quality of the items. For example, heavy items collected last may potentially crush more delicate items collected earlier. Moreover, multidimensional scaling (MDS) techniques to determine collection sequences typically are very resource intensive such that they are not feasible at production scale (e.g., thousands of store locations).

### SUMMARY

In accordance with one or more aspects of the disclosure, an online system leverages one or more machine-learning models to determine a collection sequence of items of an order. The one or more machine-learning models includes an appeasement model, and in some embodiments, may also include a timing estimation model. Sequences for collecting a plurality of items of an order are determined, and each of the sequences has a different arrangement of the plurality of items. Total appeasement values are determined for each of the sequences based in part on an appeasement model. Collection times are predicted (e.g., using the timing estimate model) for the sequences of the plurality of items. The sequences are scored based in part on the predicted appeasements and the collection times. A sequence may be selected from the sequences based in part on the scoring. The selected sequence in which to collect the items of the order is provided to a device (e.g., picker client device). A picker associated with the device may fulfill the order and collect the plurality of items in accordance with the selected sequence.

In the above manner, the online system determines a sequence to collect items of an order, where the determination is made based on the efficient collection of items as well as probabilities of appeasement of some or all of the items based on the collection sequence. Moreover, the online system can determine the sequence in a manner that is feasible at production scale.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIG. 3 is an example sequence diagram that describes leveraging machine learned models for determining collection sequence of items in an order, in accordance with some embodiments.

FIG. 4 is a flowchart for a method of leveraging an appeasement model to determine collection sequence of items of an order, in accordance with some embodiments.

### DETAILED DESCRIPTION

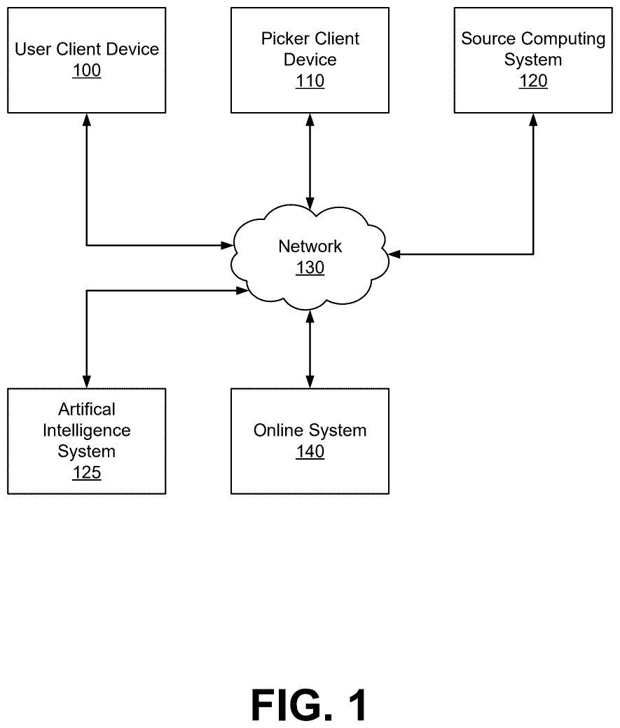

FIG. 1 illustrates an example system environment for an online system 140, in accordance with one or more embodiments. The system environment illustrated in FIG. 1 includes a user client device 100, a picker client device 110, a source computing system 120, an artificial intelligence (AI) system 125, a network 130, and an online system 140. Alternative embodiments may include more, fewer, or different components from those illustrated in FIG. 1, and the functionality of each component may be divided between the components differently from the description below. For example, some or all of the functionality of the AI system 125 may be performed by the online system 140. Additionally, each component may perform their respective functionalities in response to a request from a human, or automatically without human intervention.

Although one user client device 100, picker client device 110, AI system 125, and source computing system 120 are illustrated in FIG. 1, any number of users, pickers, AI systems, and sources may interact with the online system 140. As such, there may be more than one user client device 100, picker client device 110, AI system 125, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. In collecting items of one or more orders at a source location, the picker may place any collected items in a physical receptacle. The physical receptacle may be, e.g., a physical basket, a physical shopping cart, a smart shopping cart, a tote bag, some other physical device that can be used to carry items, etc.

The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

Each received order from the online system 140 includes a sequence for a picker to collect items of that order. The collection interface may present the items of an order in accordance with a sequence for that order. Collection of items of an order according to the received sequence mitigates chances of the picker reducing item quality (e.g., damaging) due to what order items are collected and placed in a physical receptacle (e.g., physical shopping cart). For example, a received sequence may have frozen goods collected last in order to minimize time outside of a freezer. In another example, a received sequence may have delicate items (e.g., fresh coriander) to be collected later. In this manner, the delicate items would likely be placed higher in the physical receptacle (e.g., physical shopping cart) which may help mitigate chances of them being crushed by an item that would be later added to the physical cart.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The AI system 125 may be configured to apply inputs (e.g., prompts) to one or more machine-learning models to generate responses to the prompts. The AI system 125 includes one or more machine-learning models, including, e.g., an appeasement model, and in some embodiments a timing estimation model. The one or more machine-learning models may be generative machine-learning models.

The AI system 125 may be configured to generate for one or more sequences of items, predicted appeasements for of the items. In some embodiments, there is a total appeasement value for each of the sequences. For example, the AI system 125 may receive one or more prompts to generate, for different sequences of items, total appeasement values, where each sequence has a corresponding total appeasement value. The AI system 125 may apply the one or more prompts to the appeasement model to generate the total appeasement value for each sequence. In other embodiments, for each sequence, predicated appeasements are determined for every item in the sequence. For example, the AI system 125 may receive one or more prompts to generate, for different sequences of items, predicted appeasements for the items for each of the different sequences. The AI system 125 may apply the one or more prompts to the appeasement model to generate the predicted appeasements for each sequence of the items. A predicted appeasement is a value that indicates whether an appeasement is probable for an item. For a given set of sequences of items, each of the sequences are formed from the same items, but the items are ordered differently in each of the sequences. As such, a predicted appeasement for an item may differ from one sequence to the next based in part on a position of the item within a sequence relative to one or more other items within the sequence. The relative positions indicate when an item is collected relative to other items in the sequence. The generated predicted appeasements for each sequence of the items may be provided to the online system 140.

In some embodiments, the one or more prompts may also prompt the AI system 125 to determine all possible sequences of a list of items. The AI system 125 may apply the one or more prompts a machine-learning model to generate a plurality of sequences of the items. As described above, the AI system 125 may then apply the one or more prompts to the appeasement model to generate the predicted appeasements for each sequence of the plurality of sequences of the items.

In some embodiments, the one or more prompts may also prompt the AI system 125 to predict collection times for each of the sequences. The AI system 125 may apply the one or more prompts to the timing estimation model to predict the collection times for the sequences. The predicted collection times for the sequences may be provided to the online system 140.

The user client device 100, the picker client device 110, the source computing system 120, the AI system 125, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 determines different sequences for collecting items of the order, and each of the sequences has a different arrangement of the items. The arrangement of items within a sequence indicates an order in which the items of the sequence would be collected (e.g., item in a first position is collected first, item in a second position is collected second, etc.) by a picker. In some embodiments, the online system 140 determines the different sequences using, e.g., a machine-learning model (e.g., of the AI system 125 and/or of the online system 140). In some embodiments, the online system 140 prompts the appeasement model to generate, for some or all of the sequences, predicted appeasements for the plurality of items of that sequence. In other embodiments, the online system 140 prompts the appeasement model to generate, for some or all of the sequences, corresponding total appeasement values. The online system 140 may predict (e.g., using a pick sequence algorithm and/or the timing estimation model) collection times for each of the sequences.

The online system 140 scores each of the sequences based in part on the predicted appeasements (or total appeasement values) and the collection times. For example, for each of the sequences, the online system 140 may sum the predicted appeasements to determine a total appeasement value for that sequence. Alternatively, in some embodiments (e.g., as described above), the total appeasement values may have been directly computed via the appeasement model. The online system may normalize the predicted collection times and total appeasement values for each of the sequences. The online system 140 may generate a score for a sequence by, e.g., summing (may be a weighted sum) the collection time (e.g., may be normalized) of that sequence with the total appeasement value (may be normalized) of the sequence. In this manner, the online system 140 may score each of the sequences.

The online system 140 selects a sequence of the sequences based in part on the scoring. The online system 140 may rank the sequences based on their score, and select the sequence having the lowest score. The online system 140 selects a picker to service the user's order and transmits the order and selected sequence to collect items of the order to a picker client device 110 associated with the selected picker. If the picker accepts the order, the picker collects the ordered items (in an order described by the sequence) from a source location and delivers the ordered items to the user (or to another picker who delivers the items). The online system 140 may charge a user for the order and provide portions of the payment from the user to the picker and the source.

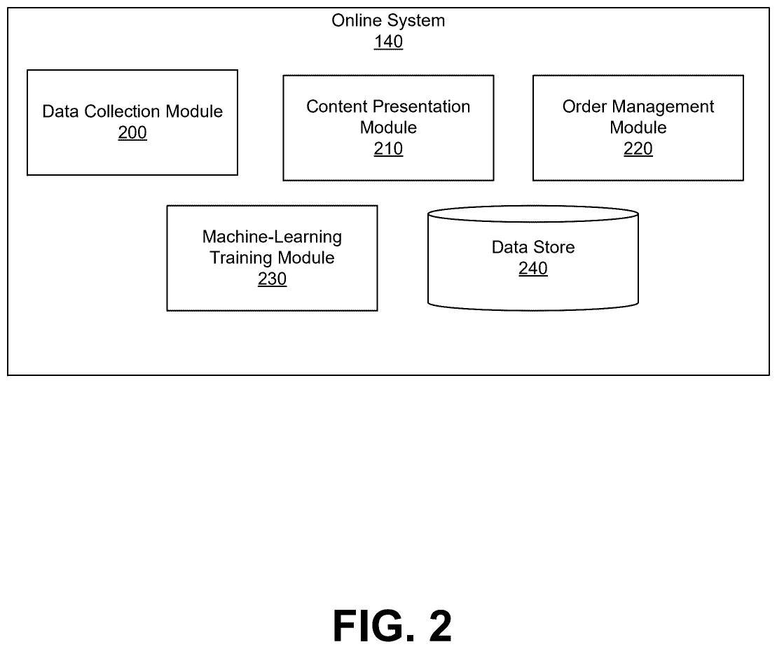

As an example, the online system 140 may allow a user to order groceries from a grocery store source. The user's order may specify which groceries they want to be delivered from the grocery store and the quantities of each of the groceries. In this example, the order includes three items, item A, Item B, and Item C. The online system 140 determines different sequences for collecting the three items of the order. There are 6 possible sequences for collecting the items, specifically, [item A, item B, item C], [item A, item C, item B], [item B, item A, item C], [item B, item C, item A], [item C, item A, item B], and [item C, item B, item A]. In this example, the online system 140 prompts the appeasement model (e.g., of the AI system 125 and/or of the online system 140) to generate, for each of the six sequences, predicted appeasements for the plurality of items of that sequence. In this manner, each item of a particular sequence has a corresponding predicted appeasement. The same item in different sequences may have different predicted appeasements. The online system 140 predicts collection times for each of the sequences (e.g., 10 minutes, 15 minutes, 8 minutes, 12 minutes, 13 minutes, and 20 minutes). The online system 140 scores each of the sequences based in part on the predicted appeasements and the collection times. For example, for a given sequence, the online system 140 may total the predicted appeasements for that sequence, and generate a score for the sequence using the total and collection time. The online system 140 may rank the scored sequences, and select a scored sequence having a lowest score from the six scored sequences. The online system 140 selects a picker to service the user's order and transmits the order and selected sequence to collect items of the order to a picker client device 110 associated with the picker. The picker travels to the grocery store source location to collect the groceries ordered by the user, where the collection is in accordance with the selected sequence. The online system 140 may transmit an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), type (e.g., frozen, refrigerated, etc.), delicateness (e.g., easily crushed), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a sequence in which items of the order were collected, whether appeasements were made to a user for an item of the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100, and determines different sequences for collecting items of the orders. Each sequence includes a plurality of potential positions for the items of an order, and for a given order of items, each sequence differs from another sequence by having at least two items in different positions. A position of an item within a sequence indicates when an item is collected relative to other items in the sequence. For example, in some embodiments, a first position within a sequence indicates that an item in that position is to be collected first, a second position indicates that an item in that position should be collected second, and so on. The order management module 220, for a given order of items, determines some or all of the possible sequences in which the items could be collected (by a picker). For example, in one embodiment, an order may include 5 items and the order management module 220 determines all possible sequences for the 5 items, such that, there are 120 different sequences (5!=120) in which the 5 items could be collected. In some embodiments, the order management module 220 generates one or more prompts to determine some or all of the sequences for items of an order. The order management module 220 may then apply the one or more prompts to the machine-learning model (e.g., of the AI system 125) to determine some or all of the sequences of items for the order.

A number of sequences scales exponentially with a number of items in an order (e.g., while there are 120 possible sequences for 5 items, there are over five thousand possible sequences for 7 items). As such, in some embodiments, the order management module 220 may determine a subset of all possible sequences in which items for an order are collected, and further process only the subset of sequences to select the sequence to provide to a picker client device. For example, the order management module 220 may use item data to identify items that have attributes which may make them sensitive to a sequence of collection. Attributes may include, e.g., size, weight, frozen item, refrigerated item, seafood item, how delicate an item is, etc. The order management module 220 may also use order data to identify items in the order that appeasements have been paid out for in the past to the user due to a reduction in item quality caused by a sequence in which the item was collected. The order management module 220 may determine all possible sequences in which items may be collected, and then select a subset (of all possible sequences) of sequences in which the identified items are located within a particular range of positions (e.g., such that frozen items are always collected last or near last). In this manner, the order management module 220 may reduce a number of sequences that are later processed to determine a sequence of collection for items of the order that is provided to a picker client device.

In some embodiments, a predicted appeasement is a value that indicates whether an appeasement is probable for an item in a given position of a sequence of item collection that includes at least one other item. In some embodiments, values for predicted appeasements are binary (e.g., 0 for low probability of appeasement and 1 for a high probability of appeasement). In some embodiments, predicted appeasements describe various probabilities of an appeasement being paid out for the item (e.g., 5.5% chance of appeasement, 75% chance of appeasement, etc.). In some embodiments, a predicted appeasement is a predicted cost (value) to be paid for an item in a given position of a sequence of item collection that includes at least one other item.

The order management module 220 may predict appeasements for sequences of items. For a set of sequences of items of an order, the order management module 220 may generate one or more prompts to generate predicted appeasements for the items. The set of sequences may be all possible sequences of the items or in some cases a subset of all possible sequences of the items. In some embodiments, the one or more prompts are to generate, for each of the set of sequences, predicted appeasements for the plurality of items, wherein the generation is based in part on picker data, order data, item data, user data, or some combination thereof. For example, the picker data may be associated with different potential pickers that could be assigned to fulfill the order for the items. The picker data may describe, e.g., picker rating, whether complaints have been filed for orders fulfilled by a picker, etc. The order data may be order histories for orders that included at least two of the items, and that include, e.g.: instances where the at least two items were added to a physical receptacle in a first sequence and there was an appeasement for an item of the at least two items, and instances where the at least two items were added to a physical receptacle in a second sequence that is different from the first sequence, and there was no appeasement for the at least two items. In some embodiments, the order management module 220 may generate one or more prompts to generate total appeasement values for each sequence.

The order management module 220 may apply the one or more prompts to a machine-learning model, specifically, an appeasement model (e.g., of the AI system 125 and/or the online system 140). In some embodiments, the appeasement model outputs, for each of the set of sequences, predicted appeasements for the items. For example, a first sequence (e.g., [Item A, Item B, Item C]) of the set of sequences has an associated set of predicted appeasements (e.g., [predicted appeasement A₁, predicted appeasement B₁, predicted appeasement C₁]) for the items as arranged in the first sequence, a second sequence e.g., [Item C, Item B, Item A]) of the set of sequences has an associated set of predicted appeasements (e.g., [predicted appeasement C₂, predicted appeasement B₂, predicted appeasement A₂]) for the items as arranged in the second sequence, and so on. Predicted appeasement values for the same item in different sequences can have different values (e.g., predicted appeasement C₂≠predicted appeasement C₁). Moreover, predicted appeasement values for a same item that is in a same position within different sequences can have different values (e.g., predicted appeasement B₁≠predicted appeasement B₂).

In alternate embodiments, the appeasement model has been trained to output a total appeasement value for each of the set of sequences. For example, for the first sequence of the set of sequences, the appeasement model may output a total appeasement value (“Vₜₒₜ₁”), for the second sequence, the appeasement model may output a total appeasement value (“Vₜₒₜ₂”), and so on.

The order management module 220 predicts collection times for each of the set of sequences. In some embodiments, the order management module 220 generates one or more prompts to predict the collection times for each of the set of sequences. In some embodiments, the order management module 220 applies the prompts to a machine-learning model, specifically, a timing estimation model (e.g., of the AI system 125). In some embodiments, the order management module 220 may determine a source location for the order (e.g., retrieve it from the order data). The order management module 220 may retrieve a layout of the source location that includes locations of items and/or item categories of the items at the source location. And the order management module 220 may prompt the timing estimation model to predict the collection time for each of the sequences based in part on the layout. The timing estimation model outputs, for each of the set of sequences, a corresponding predicted collection time. Continuing with the above example, the first sequence (e.g., [Item A, Item B, Item C]) of the set of sequences has a first predicted collection time (e.g., 15 minutes), the second sequence [Item C, Item B, Item A]) of the set of sequences has a second predicted collection time (e.g., 10 minutes), and so on.

In some embodiments, the order management module 220 predicts collection times for the set of sequences based in part on an algorithm that determines pick sequence (“a pick sequence algorithm”). The pick sequence is further described in application Ser. No. 17/855,793 filed on Jul. 1, 2022, which is hereby incorporated by reference in its entirety.

The order management module 220 scores each of the set of sequences based in part on predicted appeasements and collection times. For example, the order management module 220, for a set of sequences, may score the set of sequences based in part on total appeasement values and collection times that were determined for the sequences of the set. In embodiments where the appeasement model outputs appeasement predictions for each item of a sequence, for each sequence of the set of sequences, the order management module 220 may sum the predicted appeasements to determine a total appeasement value for the sequence. Continuing with the above example, the first sequence of [Item A, Item B, Item C] of the set of sequences has the associated set of predicted appeasements, [predicted appeasement A₁, predicted appeasement B₁, predicted appeasement C₁]. The order management module 220 sums predicted appeasement A₁, predicted appeasement B₁, and predicted appeasement C₁, where the sum is a total appeasement value (e.g., $3.40) for the first sequence. In this example, the order management module 220 would perform a similar calculation for all other sequences of the set of sequences, such that each of the sequences has a corresponding total appeasement value. In this manner, the first sequence has a corresponding total appeasement value (e.g., $3.40), the second sequence has a corresponding total appeasement value (e.g., $1.00), and so on.

The order management module 220 may generate a score for a sequence by, e.g., summing the collection time and the total appeasement value of the sequence. The order management module 220 may normalize the predicted collection times and the total appeasement values for the set of sequences. In some embodiments, normalization may be ensuring all predicted collection times share a same unit of measure and all total appeasement values also have a same unit of measure, and then dropping both units of measure. The order management module 220 may sum, for each of the sequences, a normalized collection time of the sequence with its normalized total appeasement value. Continuing with the above example, for the order management module 220, for the first sequence, the order management module 220 may normalize the predicted collection time of 15 minutes to 15, and the total appeasement value of $3.40 to 3.4, and then sum the normalized values to generate a score of 18.4. In a similar manner, the order management module 220 may, for the second sequence, normalize the predicted collection time of 10 minutes to 10, and the total appeasement value of $1.00 to 1.0, and then sum the normalized values to generate a score of 11. The order management module 220 may do this for each of the set of sequences such that each sequence of the set has a corresponding score. In some embodiments, the order management module 220 may use a weighted sum, where the total appeasement value and the collection time are weighted differently.

The online system 140 selects a sequence of the set of sequences based in part on the scoring. For example, the online system 140 may rank the sequences in the set by their scores, and select the sequence having the lowest score (e.g., a low chance of appeasement and a fast collection time relative to other sequences). The selected sequence is the sequence for collecting the items of the order that the online system 140 provides to the picker client device 110 who is assigned to fulfill the order.

The order management module 220 offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

When the order management module 220 offers an order to a picker, the order management module 220 transmits the order to the picker client device 110 associated with the picker. The order management module 220 also provides to the picker client device 110 the selected sequence for collecting the items of the order. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data, which may be referred to respectively as, training user data, training picker data, training item data, and training order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

For example, the machine-learning training module 230 may train the appeasement model to predict appeasements of items. The machine-learning training module 230 may access a set of training examples including training order data (e.g., for sets of items that were collected in different sequences), and the set may also include, e.g., training picker data, training item data, training user data, or some combination thereof. The machine-learning training module 230 may apply the appeasement model to the set of training examples to generate a training output corresponding to sets of predicted appeasements for the different sequences. The machine-learning training module 230 may back-propagate one or more error terms obtained from one or more loss functions to update a set of parameters of the appeasement model. One or more of the error terms may be based on a difference between a label applied to a test interaction of the set of training examples and the set of predicted appeasements for the different sequences. The machine-learning training module 230 may stop the back-propagation after the one or more loss functions satisfy one or more criteria.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

For example, the machine-learning training module 230 may re-train the appeasement model to predict appeasements. The machine-learning training module 230 may generate training examples based on appeasements made for an item in orders collected by pickers in various sequences, and orders of various sequences that included the item where no appeasement was paid for the item. The machine-learning training module 230 may label each training example based on a comparison of a resolution of the training example to a metric associated with the online system 140. The metric may be, e.g., less than a threshold number of appeasements paid while maintaining a threshold level of profitability per order. The machine-learning training module 230 may retrain the appeasement model using the labeled training examples.

The data store 240 stores data used by the online system 140. For example, the data store 240 stores user data, item data, order data, and picker data for use by the online system 140. The data store 240 also stores trained machine-learning models (e.g., appeasement model, timing estimation model) trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

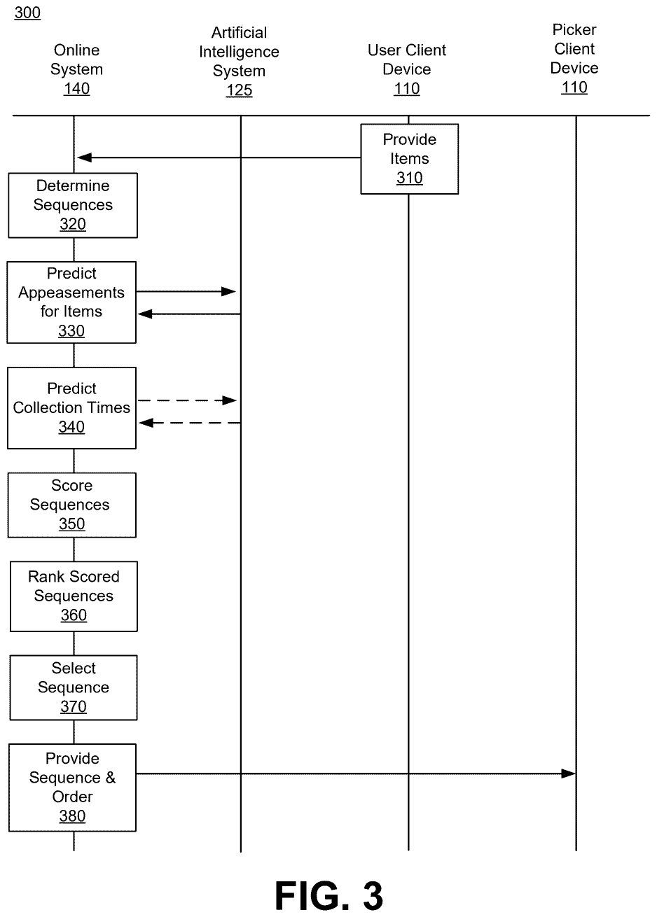

FIG. 3 is an example sequence diagram 300 that describes leveraging machine learned models for determining collection sequence of items in an order, in accordance with some embodiments. Alternative embodiments may include more, fewer, or different interactions from those illustrated in FIG. 3, and the steps may be performed in a different order from that illustrated in FIG. 3. The sequence diagram 300 describes some actions of the user client device 100, the picker client device 110, the AI system 125, and the online system 140. Alternative embodiments may include more, fewer, or different components from those illustrated in FIG. 3, and the functionality of each component may be divided between the components differently from the description below. For example, some or all of the functionality of the AI system 125 may be performed by the online system 140.

The user client device 100 receives items for an order. For example, a user of the user client device 100 may select the items from an online catalog of the online system 140. The user client device 100 provides 310 the items to the online system 140 for ordering.

The online system 140 determines 320 a set of sequences for collecting the items of the order. In some embodiments, the set of sequences includes all of the possible sequences in which the items could be collected (e.g., by a picker). In embodiments (not shown in FIG. 3), the online system 140 may generate one or more prompts to determine all of the sequences for items of the order. The online system 140 may then apply the one or more prompts to a machine-learning model of the AI system 125 to determine all of the sequences of items for the order.

In some embodiments, the set of sequences is a subset of all possible sequences in which items for an order could be collected. For example, the online system 140 may use item data to identify items that have attributes which may make them sensitive to a sequence of collection and/or use order data to identify items in the order that appeasements have been paid out for in the past to the user due to a reduction in item quality caused by a sequence in which the item was collected. The online system 140 may determine all possible sequences in which items may be collected, and then select a subset (of all possible sequences) of sequences in which the identified items are located within a particular range of positions (e.g., such that frozen items are always collected last or near last). In this manner, the online system 140 may reduce a number of sequences that are later processed to determine a sequence of collection for items of the order that is provided to a picker.

The online system 140 predicts 330, for the set of sequences, appeasements for the items. The online system 140 generates one or more prompts to generate, for the set of sequences, predicted appeasements for the items. In some embodiments, the generation is based in part on picker data, order data, user data, item data, or some combination thereof. The online system 140 applies the one or more prompts to an appeasement model of the AI system 125. The appeasement model outputs, for each of the set of sequences, a corresponding set of predicted appeasements for the items. For example, the set of sequences may include just two sequences of two different items, specifically a first sequence of [Item A, Item B], and a second sequence of [Item B, Item A]. The appeasement model may output predicted appeasements for the items of the first sequence and the second sequence, such that for the first sequence Item A has a first predicted appeasement (“PA₁”), and item B has a first predicted appeasement (“PB₁”); and for the second sequence Item B has a second predicted appeasement (“PB₂”), and item A has a second predicted appeasement (“PA₂”).

The online system 140 predicts 340 collection times for the set of sequences. In some embodiments, the online system 140 generates one or more prompts to predict the collection times for each of the set of sequences. The online system 140 may apply the one or more prompts to a timing estimation model of the AI system 125. In some embodiments, the online system 140 may retrieve a layout (e.g., that includes locations of items and/or item categories of the items at the source location) of a source location associated with the order. And the one or more prompts to predict the collection times may be based in part on the layout. In some embodiments, the online system 140 predicts collection times for the set of sequences based in part on a pick sequence algorithm. Continuing with the above example, the first sequence may have a first predicted collection time (“T₁”), and the second sequence a second predicted collection time (“T₂”).

The online system 140 scores 350 each of the set of sequences based in part on the predicted appeasements and the collection times. For each sequence of the set of sequences, the online system 140 may sum the predicted appeasements to determine a total appeasement value for the sequence. For example, a total appeasement value for sequence 1 (“Vₜₒₜ₁”) is a sum of PA₁ and PB₁, and a total appeasement value for sequence 2 (“Vₜₒₜ₂”) is a sum of PB₂ and PA₂. The online system 140 may generate a score for a sequence by, e.g., summing (may be a weighted sum) the predicted collection time of that sequence with the total appeasement value of the sequence. For example, the online system 140 may normalize the total appeasement values (e.g., Vₜₒₜ₁ and Vₜₒₜ₂) and the predicted collection times (T₁ and T₂). The online system may then for each sequence, sum the normalized predicted collection time for that sequence with the normalized appeasement value for that sequence. In the two sequence example, discussed above, the online system 140 may determine for the first sequence a score (“S₁”) that is a sum of the normalized T₁ and the normalized Vₜₒₜ₁, and determine for the second sequence a score (“S₂”) that is a sum of the normalized T₂ and the normalized Vₜₒₜ₂.

In FIG. 3, the appeasement model outputs appeasement predictions for each item, which are later summed to determine total appeasement values. In other embodiments, the appeasement model is trained to directly output the total appeasement value of a sequence.

The online system 140 ranks 360 the sequences based in part on the scoring. For example, the online system 140 may rank the scored sequences, e.g., from lowest to highest score. The online system 140 selects 370 a sequence from the ranked sequences. For example, the online system 140 may select a sequence having a lowest score. The online system 140 provides 380 the order and the selected sequence to the picker client device 110 of a picker assigned to fulfill the order. The picker may use the selected sequence to collect the items of the order from the source location.

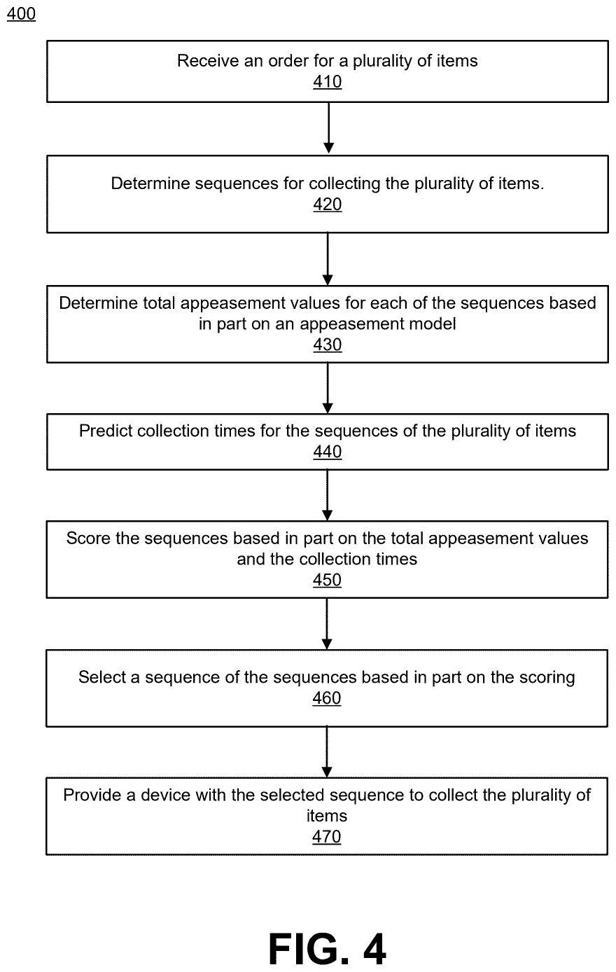

FIG. 4 is a flowchart 400 for a method of leveraging an appeasement model to determine collection sequence of items of an order, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system 140 receives 410 an order for items. The online system receives the order from a user client device (e.g., the user client device 100) associated with a user. The order may specify, e.g., a source location to fulfill the order.

The online system determines 420 sequences for collecting the plurality of items. Each of the sequences has a different arrangement of the items. In some embodiments, the sequences are all possible sequences of the items. In other embodiments, the sequences are a subset of all the possible sequences of the items. For example, the online system 140 may use item data to identify one or more items in the order that have attributes which may make them sensitive to a sequence of collection and/or use order data to identify one or more items in the order that appeasements have been paid out for in the past to the user due to a reduction in item quality caused by a sequence in which the item was collected. The online system may select a subset of all the possible sequences, where in the subset of sequences the identified one or more items are located within a particular range of positions (e.g., such that frozen items are always collected last or near last).

The online system determines 430 total appeasement values for each of the sequences based in part on an appeasement model. In some embodiments, the online system generates one or more prompts to generate, for the sequences, predicted appeasements for the items. The generation may be based in part on picker data, order data, user data, item data, or some combination thereof. The online system applies the one or more prompts to the appeasement model (e.g., of the AI system 125 and/or the online system). The appeasement model outputs, for each of the sequences, a corresponding set of predicted appeasements for the items. For each sequence of the set of sequences, the order online system may sum the predicted appeasements to determine a total appeasement value for that sequence. For example, if there were ten difference sequences, there would be ten different total appeasement values (i.e., one for each sequence). In some embodiments, the online system generates one or more prompts to generate, for the sequences, total appeasement values for each of the sequences. The online system applies the one or more prompts to the appeasement model which outputs a respective total appeasement value for each of the sequences.

The online system predicts 440 collection times for the sequences of the plurality of items. In some embodiments, the online system generates one or more prompts to predict the collection times for each of the set of sequences. The online system may apply the one or more prompts to a timing estimation model. In some embodiments, the online system may retrieve a layout of the source location associated with the order. And the one or more prompts to predict the collection times may be based in part on the layout. In some embodiments, the online system predicts collection times for the set of sequences based in part on a pick sequence algorithm.

The online system scores 450 the sequences based in part on the predicted appeasements and the collection times. The online system may generate a score for a sequence by, e.g., summing (may be a weighted sum) the collection time (e.g., may be normalized) of that sequence with the total appeasement value (may be normalized) of the sequence.

The online system selects 460 a sequence of the sequences based in part on the scoring. The online system ranks the scored sequences. The online system selects the sequence having the lowest score.

The online system provides 470 a device with the selected sequence to collect the plurality of items. The device may be a picker client device (e.g., the picker client device 110). The online system may provide the sequence as part of the order to the device. A picker associated with the device may use the selected sequence to collect the items of the order from the source location.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
generating a plurality of sequences for collecting a plurality of items of an order, where each sequence of the plurality of sequences has a different arrangement of the plurality of items;
for each of the plurality of sequences, applying an appeasement model to predict a total appeasement value for the sequence;
generating a predicted collection time for each of the plurality of sequences;
scoring the plurality of sequences based in part on the total appeasement values and the collection times;
selecting a sequence from the plurality of sequences based in part on the scoring; and
sending the selected sequence to a device, wherein sending the selected sequence to the device causes the device to display the selected sequence for collecting the plurality of items.

2. The method of claim 1, wherein generating a predicted collection time for each of the plurality of sequences comprises:
applying a timing estimation model to predict a collection time for each of the sequences.

3. The method of claim 2, further comprising:
retrieving a layout of a source location,
wherein applying the timing estimation model to predict the collection time for each of the sequences, comprises applying the timing estimation model to the layout of the source location.

4. The method of claim 1, wherein, for each of the plurality of sequences, applying the appeasement model to predict the total appeasement value for the sequence comprises:
applying the appeasement model to generate, for the sequence, a predicted appeasement value for each the plurality of items in the sequence; and
summing the predicted appeasement values for each the plurality of items of the sequence to generate the total appeasement value for the sequence.

5. The method of claim 4, wherein applying the appeasement model to generate, for the sequence, the predicted appeasement value for each the plurality of items in the sequence comprises:
applying the appeasement model to order data associated with the items, the order data including order histories for orders that included at least two of the items, wherein the order histories include:
instances where the at least two items were added to a physical receptacle in a first sequence and there was an appeasement for an item of the at least two items, and
instances where the at least two items were added to a physical receptacle in a second sequence that is different from the first sequence, and there was no appeasement for the at least two items.

6. The method of claim 1, wherein the appeasement model was trained by:
accessing a set of training examples including training order data for sets of items that were collected in different sequences and training item data;
applying the appeasement model to the set of training examples to generate a training output corresponding to sets of predicted appeasements for the different sequences;
back-propagating one or more error terms obtained from one or more loss functions to update a set of parameters of the appeasement model, and one or more of the error terms are based on a difference between a label applied to a test interaction of the set of training examples and the set of predicted appeasements for the different sequences; and
stopping the back-propagation after the one or more loss functions satisfy one or more criteria.

7. The method of claim 1, further comprising:
generating, by the computer system, training examples based on appeasements made for an item in in a first set of orders having different sequences, and orders of a second set of sequences that included the item where no appeasement was made for the item;
labeling each training example based on a comparison of a resolution of the training example to a metric associated with the computer system; and
retraining the appeasement model using the labeled training examples.

8. A computer program product comprising a non-transitory computer readable storage medium having instructions encoded thereon that, when executed by a processor of a computer system, cause the computer system to perform steps comprising:
generating a plurality of sequences for collecting a plurality of items of an order, where each sequence of the plurality of sequences has a different arrangement of the plurality of items;
for each of the plurality of sequences, applying an appeasement model to predict a total appeasement value for the sequence;
generating a predicted collection time for each of the plurality of sequences;
scoring the plurality of sequences based in part on the total appeasement values and the collection times;
selecting a sequence from the plurality of sequences based in part on the scoring; and
sending the selected sequence to a device, wherein sending the selected sequence to the device causes the device to display the selected sequence for collecting the plurality of items.

9. The computer program product of claim 8, wherein generating a predicted collection time for each of the plurality of sequences comprises:
applying a timing estimation model to predict a collection time for each of the sequences.

10. The computer program product of claim 9, further comprising encoded instructions that when executed cause the computer system to perform steps comprising:
retrieving a layout of a source location,
wherein applying the timing estimation model to predict the collection time for each of the sequences, comprises applying the timing estimation model to the layout of the source location.

11. The computer program product of claim 8, wherein, for each of the plurality of sequences, applying the appeasement model to predict the total appeasement value for the sequence comprises:
applying the appeasement model to generate, for the sequence, a predicted appeasement value for each the plurality of items in the sequence; and
summing the predicted appeasement values for each the plurality of items of the sequence to generate the total appeasement value for the sequence.

12. The computer program product of claim 11, wherein applying the appeasement model to generate, for the sequence, the predicted appeasement value for each the plurality of items in the sequence comprises:
applying the appeasement model to order data associated with the items, the order data including order histories for orders that included at least two of the items, wherein the order histories include:
instances where the at least two items were added to a physical receptacle in a first sequence and there was an appeasement for an item of the at least two items, and
instances where the at least two items were added to a physical receptacle in a second sequence that is different from the first sequence, and there was no appeasement for the at least two items.

13. The computer program product of claim 8, wherein the appeasement model was trained by:
accessing a set of training examples including training order data for sets of items that were collected in different sequences and training item data;
applying the appeasement model to the set of training examples to generate a training output corresponding to sets of predicted appeasements for the different sequences;
back-propagating one or more error terms obtained from one or more loss functions to update a set of parameters of the appeasement model, and one or more of the error terms are based on a difference between a label applied to a test interaction of the set of training examples and the set of predicted appeasements for the different sequences; and
stopping the back-propagation after the one or more loss functions satisfy one or more criteria.

14. The computer program product of claim 8, further comprising encoded instructions that when executed cause the computer system to perform steps comprising:
generating training examples based on appeasements made for an item in in a first set of orders having different sequences, and orders of a second set of sequences that included the item where no appeasement was made for the item;
labeling each training example based on a comparison of a resolution of the training example to a metric associated with the computer system; and
retraining the appeasement model using the labeled training examples.

15. A computer system comprising:
a processor; and
a non-transitory computer readable storage medium having instructions encoded thereon that, when executed by the processor, cause the computer system to perform steps comprising:
generating a plurality of sequences for collecting a plurality of items of an order, where each sequence of the plurality of sequences has a different arrangement of the plurality of items;
for each of the plurality of sequences, applying an appeasement model to predict a total appeasement value for the sequence;
generating a predicted collection time for each of the plurality of sequences;
scoring the plurality of sequences based in part on the total appeasement values and the collection times;
selecting a sequence from the plurality of sequences based in part on the scoring; and
sending the selected sequence to a device, wherein sending the selected sequence to the device causes the device to display the selected sequence for collecting the plurality of items.

16. The computer system of claim 15, wherein generating a predicted collection time for each of the plurality of sequences comprises:
applying a timing estimation model to predict a collection time for each of the sequences.

17. The computer system of claim 16, further comprising encoded instructions that when executed cause the computer system to perform steps comprising:
retrieving a layout of a source location,
wherein applying the timing estimation model to predict the collection time for each of the sequences, comprises applying the timing estimation model to the layout of the source location.

18. The computer system of claim 15, wherein, for each of the plurality of sequences, applying the appeasement model to predict the total appeasement value for the sequence comprises:
applying the appeasement model to generate, for the sequence, a predicted appeasement value for each the plurality of items in the sequence; and
summing the predicted appeasement values for each the plurality of items of the sequence to generate the total appeasement value for the sequence.

19. The computer system of claim 18, wherein applying the appeasement model to generate, for the sequence, the predicted appeasement value for each the plurality of items in the sequence comprises:
applying the appeasement model to order data associated with the items, the order data including order histories for orders that included at least two of the items, wherein the order histories include:
instances where the at least two items were added to a physical receptacle in a first sequence and there was an appeasement for an item of the at least two items, and
instances where the at least two items were added to a physical receptacle in a second sequence that is different from the first sequence, and there was no appeasement for the at least two items.

20. The computer system of claim 15, wherein the appeasement model was trained by:
accessing a set of training examples including training order data for sets of items that were collected in different sequences and training item data;
applying the appeasement model to the set of training examples to generate a training output corresponding to sets of predicted appeasements for the different sequences;
back-propagating one or more error terms obtained from one or more loss functions to update a set of parameters of the appeasement model, and one or more of the error terms are based on a difference between a label applied to a test interaction of the set of training examples and the set of predicted appeasements for the different sequences; and
stopping the back-propagation after the one or more loss functions satisfy one or more criteria.
